(19) United States
(12) Patent Application Publication
(10) Pub. No.: US 2009/0182998 A1
(43) Pub. Date: Jul. 16, 2009

(54) Method And System For Specifying Timestamp Properties For Object Marking And Protocol Exchange

(76) Inventor: Scott Krig, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 12/195,262

(22) Filed: Aug. 20, 2008

Related U.S. Application Data
(60) Provisional application No. 61/021,489, filed on Jan. 16, 2008.
(60) Provisional application No. 61/073,985, filed on Jun. 19, 2008.

(51) Int. Cl. H04L 9/00

(52) U.S. Cl. 713/156

(57) ABSTRACT

An extension of the media transfer protocol (MTP) may enable marking an object by specifying information about activity pertaining to the object via an object property. The object property information may be communicated to and/or from a device that supports MTP communications. Object properties may comprise timestamps corresponding to when an object is received, generated and/or accessed or information regarding what activity was performed on the object, who or what entity initiated or executed the activity and/or a history of the activity. Object property information based on a corresponding ObjectPropDesc dataset may be communicated between devices during initiation of communication or via a response to a request such as a GetObjectPropDesc or GetObjectPropValue operation. Information about activity pertaining to the object may be logged and/or audited based on the object properties.

### CROSS-REFERENCE TO RELATED APPLICATIONS/INCORPORATION BY REFERENCE

This application makes reference to, claims priority to, and claims the benefit of U.S. Provisional Application Ser. No. 61/021,489, filed on Jan. 16, 2008, entitled “METHOD AND SYSTEM FOR SPECIFYING TIMESTAMP PROPERTIES FOR OBJECT MARKING AND PROTOCOL EXCHANGE,” which is incorporated herein by reference in its entirety.

This application makes reference to, claims priority to, and claims the benefit of U.S. Provisional Application Ser. No. 61/073,985, filed on Jun. 19, 2008, entitled “METHOD AND SYSTEM FOR SPECIFYING TIMESTAMP PROPERTIES FOR OBJECT MARKING AND PROTOCOL EXCHANGE,” which is incorporated herein by reference in its entirety.

### FIELD OF THE INVENTION

Certain embodiments of the invention relate to multimedia communication. More specifically, certain embodiments of the invention relate to a method and system for specifying timestamp properties for object marking and protocol exchange.

### BACKGROUND OF THE INVENTION

The media transfer protocol (MTP) is an extension of the industry standard picture transfer protocol (PTP). The media transfer protocol was created as an extension to the picture transfer protocol specifically for media devices and includes various provisions for digital rights management (DRM).

Digital rights management (DRM) and electronic license management technologies may be utilized for home video, music, consumer and enterprise software markets. Motion picture studios, cable and satellite TV operators, consumer electronics companies and personal computer manufacturers use DRM technologies to prevent the unauthorized duplication, reception or use of copyrighted video materials.

PIMA 15740:2000 provides a common communication mechanism for exchanging images with and between digital still photography devices (DSPDs). This includes communication between digital still photography devices and host computers, printers, other digital still devices, telecommunications kiosks, and image storage and display devices. This standard presents a protocol that is intended to be transport and platform independent. The purpose of this intent is to enable standard behavior by allowing implementation of the protocol in a variety of standard transports. Exemplary transports include USB (Universal Serial Bus), IEEE 1394, and IrDA (Infrared Data Association). This standard specifies the following:

Behavior requirements for DSPDs include: baseline features a device needs to support to provide interoperability over conforming transports; functional requirements needed by a transport to enable the creation of a transport-dependent implementation specification that conforms to this standard; and a high-level protocol for communicating with and between DSPDs consisting of operation, data, and response phases.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for specifying timestamp properties for object marking and protocol exchange, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of exemplary media devices enabled to modify and/or communicate MTP object marking properties via an extension of the MTP standard, in accordance with an embodiment of the invention.

FIG. 2 is a flow chart illustrating exemplary steps for marking an MTP object via a plurality of object properties.

FIG. 3 is a flow chart illustrating exemplary steps for communicating MTP object marking properties from a first device to a second device.

FIG. 4 is a flow chart illustrating exemplary steps for an MTP object marking usage scenario, in accordance with an embodiment of the invention.

### DETAILED DESCRIPTION OF THE INVENTION

Aspects of the invention may be found in a method and system for specifying timestamp properties for object marking and protocol exchange. In this regard, an extension of the media transfer protocol (MTP) may enable marking an object by specifying information about activity pertaining to the object. In addition, the specified information may be communicated to and/or from a device that supports MTP communications. In accordance with various embodiments of the invention, the object may be, for example, an audio, video or text file, a program or application information such as contacts. The information about activity pertaining to an object or file may be recorded within one or more object properties. For example, a timestamp may be indicated within an object property when the corresponding object is received, generated and/or accessed by a media device. Furthermore, one or more object properties may indicate what action occurred with regard to the object and who or what source initiated or executed the action. Moreover, one or more object properties may comprise a history or accumulation of information about activity pertaining to an object, for example, which activity occurred, when it occurred and/or who or what source initiated or executed the activity.

In various embodiments of the invention, a device may communicate the object activity object properties to another device during initiation of communication between the devices. In addition, object properties marking activity involving an object may be communicated or specified in a response to a request for the information. For example, one or more MTP operations such as GetObjectPropDesc or GetObjectPropValue may be utilized to request the object activity information. Corresponding responses may comprise an ObjectPropDesc dataset or an object property current value from the ObjectPropDesc dataset, respectively. In this manner, an object may be marked with regard to utilization or activity involving the object and the marked information may be communicated via MTP. In this regard, the information about activity pertaining to an object may be logged and/or audited based on the object properties.

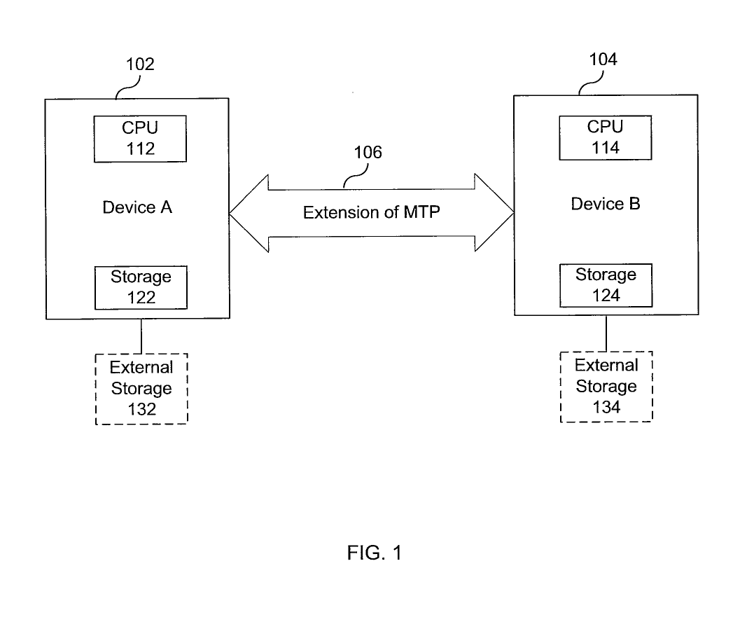

FIG. 1 is a block diagram of exemplary media devices enabled to modify and/or communicate MTP object marking properties via an extension of the MTP standard, in accordance with an embodiment of the invention. Referring to FIG. 1 there is shown an extension of the media transfer protocol (MTP) 106 that may facilitate communication between a device 102 and a device 104. The devices 102 and 104 may comprise processors 112 and 114 respectively, internal storage 122 and 124 respectively and/or external storage 132 and 134 respectively.

The device 102 may comprise suitable logic, circuitry and/or code that may enable transfer of information to and/or from the device 104 via MTP and an extension of the MTP 106. The device 102 may be a media device that may comprise suitable processing 112 and storage capacity 122 and/or 132 for consuming and/or producing media objects. Moreover, the device 102 may be enabled to function as an initiator device with regard to MTP operations. The device 102 may be for example, a host computer or PC. In various embodiments of the invention, the device 102 may enable marking MTP objects via object properties and/or communicating object property information with the device 104.

The device 104 may comprise suitable logic, circuitry, and/or code that may enable transfer of information to and/or from the device 104 via MTP and an extension of the MTP 106. The device 104 may be a media device that may comprise suitable processing 114 and storage capacity 124 and/or 134 for consuming and/or producing media objects. Moreover, the device 104 may be, for example, enabled to function as a responder device with regard to MTP operations. For example, the device 104 may be a still or video digital camera, a portable media player, a cell phone or PC. In various embodiments of the invention, the device 104 may enable marking MTP objects via object properties and/or communicating object property information with the device 102.

The extension of the MTP 106 may comprise modified specifications within the MTP architecture that may enable marking MTP objects, for example, storing information about MTP objects, via MTP object properties and/or communicating the MTP properties between the device 102 and device 104. MTP objects may comprise, for example, data, corresponding metadata and/or object reference data wherein the data may comprise audio and/or video files, text files, programs, scheduled events or contact information for example. In this regard, the extension to the MTP 106 may comprise one or more object properties conveying information about activity such as accessing, modifying and/or communicating an MTP object. More specifically, the one or more object properties may comprise information regarding when an object was accessed, what activity may have been performed with regard to the accessed object and/or who or what resource initiated the access.

A plurality of properties within the extension of the MTP 106 may provide information as to when an object was accessed and/or modified. These properties may effectively mark an object with a timestamp to indicate a history of activity for the object. In this regard, an MTP timestamp string may be utilized that may comprise an extended ISO 8601 date/time format wherein a Greenwich Mean Time Offset (GMTO) may indicate an offset in hours for international time zone support. For example, a timestamp string may be formatted in the following manner:

[GMTO-YYYY-MM-DD-HH-MM-SS-MMM-UUU-NNN-PPP].

The timestamp string format may be defined in Table 1. An exemplary timestamp string for Jan. 1, 2007, 12:30 p.m, zero seconds and zero GMT offset may be formatted as 0-2007-01-01-12-30-00.

TABLE 1
Timestamp String Format

| Format Position | Meaning | Range | Required |
|---|---|---|---|
| GMTO | GMT offset | 0 . . . 23 | Yes |
| YYYY | year | 0000 . . . current year | Yes |
| MM | Month | 01 . . . 12 | Yes |
| DD | Day | 01 . . . 31 | Yes |
| HH | Hour | 01 . . . 24 | Yes |
| MM | Minute | 01 . . . 60 | Yes |
| SS | Seconds | 01 . . . 60 | Yes |
| MMM | Milliseconds | 000 . . . 999 | *Optional |
| UUU | Microseconds | 000 . . . 999 | *Optional |
| NNN | Nanoseconds | 000 . . . 999 | *Optional |
| PPP | Picoseconds | 000 . . . 999 | *Optional |

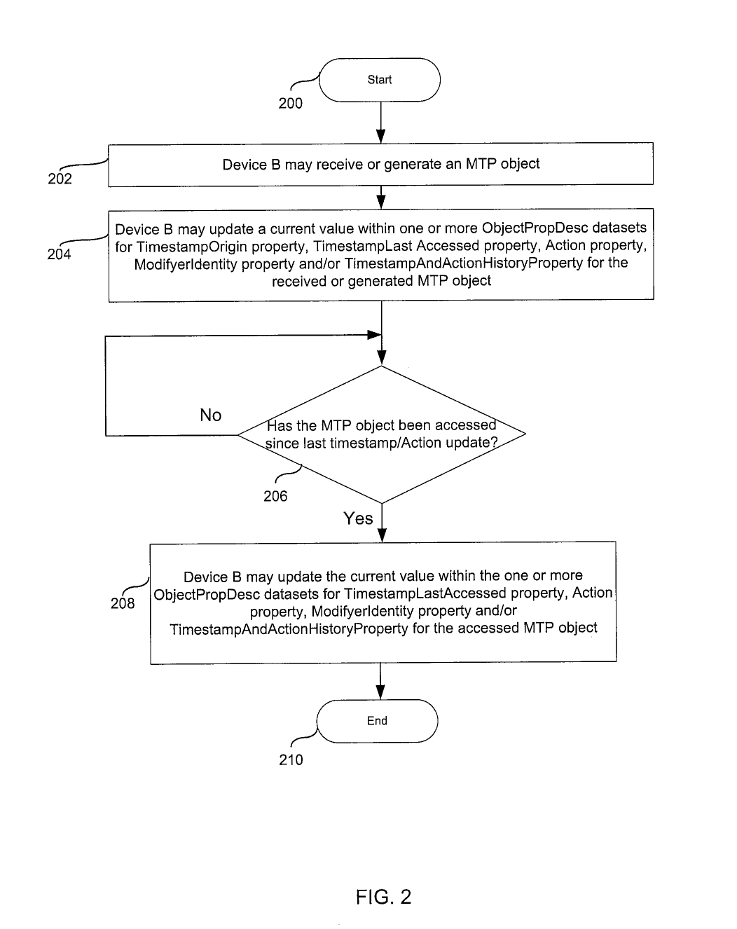

In various embodiments of the invention, a TimestampOrigin property may be utilized to mark any object with a timestamp string when an object is received or generated. An object property description may be described as in FIG. 2.

TABLE 2
TimestampOrigin Property

| | | Size | | |
|---|---|---|---|---|
| Field name | Field order | (bytes) | Datatype | Value |
| PropertyCode | 1 | 2 | UINT16 | 0xDXXX |
| Datatype | 2 | 2 | UINT16 | 0xFFFF (STRING) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

In addition, a TimestampLastAccessed property shown in Table 3, may be utilized to mark any object with a timestamp string in MTP timestamp format that may indicate when the object was last accessed.

TABLE 3
TimestampLastAccessed Property

| | | Size | | |
|---|---|---|---|---|
| Field name | Field order | (bytes) | Datatype | Value |
| PropertyCode | 1 | 2 | UINT16 | 0xDXXX |
| Datatype | 2 | 2 | UINT16 | 0xFFFF (STRING) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

In accordance with an embodiment of the invention, an object property may be utilized to mark any object with respect to what activity or action was last performed on the object. In this regard an Action property shown in Table 4, may comprise a generic string indicating the last action performed on the object. The invention is not limited to any specific action string value and may comprise any suitable action string value pertaining to any object. Exemplary actions may comprise an object read, write, delete, send, certificate update or partial write.

TABLE 4
Action Property

| | | Size | | |
|---|---|---|---|---|
| Field name | Field order | (bytes) | Datatype | Value |
| PropertyCode | 1 | 2 | UINT16 | 0xDXXX |
| Datatype | 2 | 2 | UINT16 | 0xFFFF (STRING) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

Furthermore, an MTP ModifyerIdentity object property may mark any object and may comprise a generic string indicating the identity of a cause or source of an action performed on the object. Exemplary ModifyerIdentity strings may comprise an application name, GUID, URL, MAC address, IPaddress, phone number, street address, email address, program name or build date. The ModifyerIdentity property may defined as in Table 5.

TABLE 5
ModifyerIdentity Property

| | | Size | | |
|---|---|---|---|---|
| Field name | Field order | (bytes) | Datatype | Value |
| PropertyCode | 1 | 2 | UINT16 | 0xDXXX |
| Datatype | 2 | 2 | UINT16 | 0xFFFF (STRING) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

Moreover, a TimestampAndActionHistory property defined in Table 6 may comprise a plurality of MTP timestamps and action strings that may provide a history of activity for an MTP object. In this regard, object marking property strings may be concatenate such that a list of strings may be updated when activity regarding an MTP object occurs. A list of timestamps and/or action strings may be formatted in the following manner.

[“TimestampOrigin”][“TimestampLastAccessed”][“Action”][ModifyerIdentity]

TABLE 6
TimestampAndActionHistory Property

| | | Size | | |
|---|---|---|---|---|
| Field name | Field order | (bytes) | Datatype | Value |
| PropertyCode | 1 | 2 | UINT16 | 0xDXXX |
| Datatype | 2 | 2 | UINT16 | 0x4002 (AUINT8) |
| Get/Set | 3 | 1 | UINT8 | 0x01 (GET/SET) |
| DefaultValue | 4 | | | 0x00 (Null String) |
| GroupCode | 5 | 4 | UINT32 | Device-defined |
| FormFlag | 6 | 1 | UINT8 | 0x00 None |

In operation, device 102 shown in FIG. 1 may be a host computer that may download media content to a device 104 that may be for example a handheld media device. The devices 102 and 104 may support the MTP extension 106 comprising object marking properties. In this regard, the device 104 may update the current value of the object marking properties for the downloaded object. For example, TimestampOrigin, TimestampLastAccessed, Action, ModifyerIdentity and/or TimestampandActionHistory properties may be updated as actions occur with regard to the downloaded object. The devices 102 and 104 may be enabled to utilize MTP operations to exchange object marking information. For example, the device 102 may utilize a GetObjectPropValue operation to retrieve an ObjectPropDesc dataset for the TimestampAndActionHistory property corresponding to the downloaded object. A log may be created from information the retrieved dataset for audit activity on the device 104 with regard to the downloaded object.

FIG. 2 is a flow chart illustrating exemplary steps for marking an MTP object via a plurality of object properties. Referring to FIG. 2, after start step 200, in step 202, device B 104 may receive or generate an MTP object comprising, for example, data. In step 204, device B 104 may update a current value within one or more ObjectPropDesc datasets for TimestampOrigin property, TimestampLast Accessed property, Action property, ModifyerIdentity property and/or TimestampAndActionHistoryProperty for the received or generated MTP object. In step 206, if the MTP object has been accessed since last timestamp/Action update, proceed to step 208. In step 208, device B 104 may update the current value within the one or more ObjectPropDesc datasets for TimestampLastAccessed property, Action property, ModifyerIdentity property and/or TimestampAndActionHistoryProperty for the accessed MTP object. Step 210 may be the end of exemplary steps.

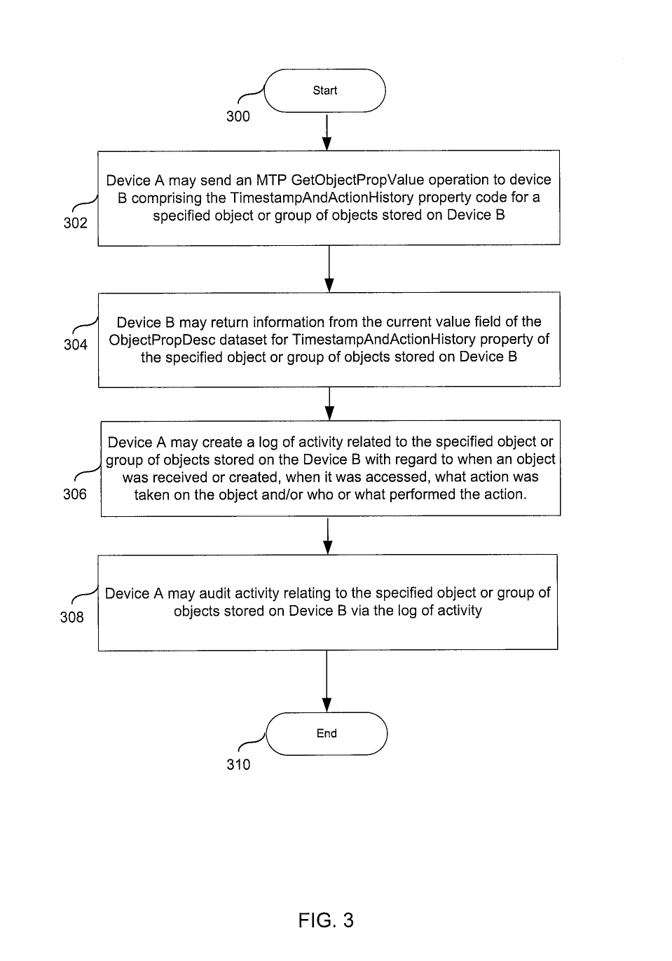

FIG. 3 is a flow chart illustrating exemplary steps for communicating MTP object marking properties from a first device to a second device. Referring to FIG. 3, after start step 300, in step 302, device A 102 may send an MTP GetObjectPropValue operation to device B 104 comprising the TimestampAndActionHistory property code for a specified object stored on Device B 104. In step 304, device B 104 may return information from the current value field of the ObjectPropDesc dataset for TimestampAndActionHistory property of the specified object stored on Device B 104. In step 306, device A 102 may create a log of activity related to the specified object stored on the Device B 104 with regard to when the object was received or created, when it was accessed, what action was taken on the object and/or who or what performed the action. In step 308, device A 102 may audit activity relating to the specified object stored on device B 104 via the log of activity. Step 310 may be the end of exemplary steps.

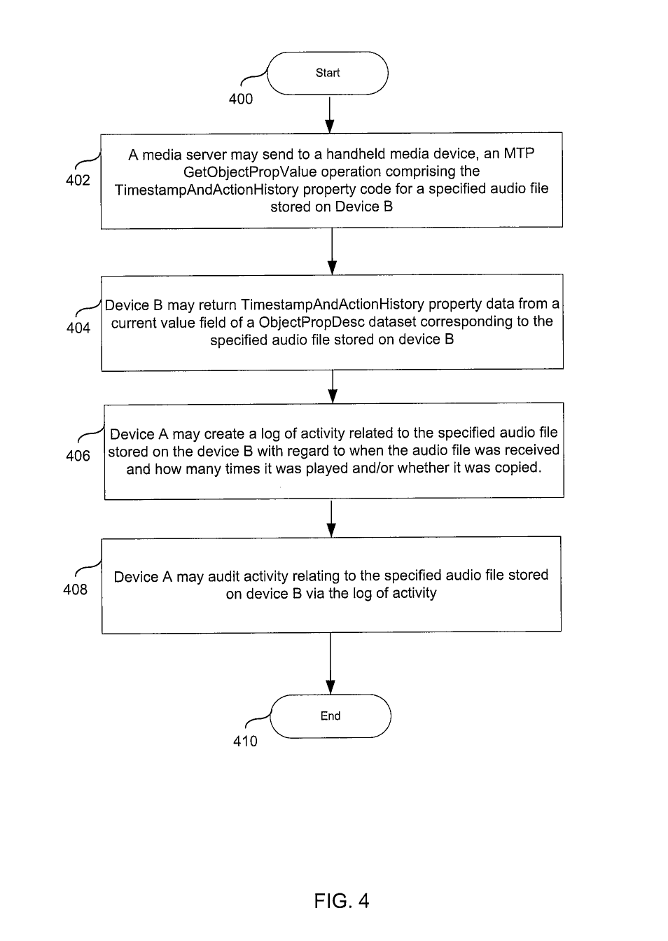

FIG. 4 is a flow chart illustrating exemplary steps for an MTP object marking usage scenario, in accordance with an embodiment of the invention. Referring to FIG. 4, after start step 400, in step 402 a media server that may be represented by device 102, may send to a handheld media device that may be represented by the device 104, an MTP GetObjectPropValue operation comprising the TimestampAndActionHistory property code for a specified audio file stored on device B 104. In step 404, device B 104 may return TimestampAndActionHistory property data from a current value field of an ObjectPropDesc dataset corresponding to the specified audio file stored on device B 104. In step 406, device A 102 may create a log of activity related to the specified audio file stored on the device B 104 with regard to when the audio file was received and how many times it was played and/or whether it was copied. In step 408, device A 102 may audit activity relating to the specified audio file stored on device B 104 via the log of activity. Step 410 may be the end of exemplary steps. Step 410 may be the end of exemplary steps.

A method and system for marking one or more MTP objects via object marking properties and exchanging object marking properties between devices 102 and 104 may be specified in one or more extensions of media transfer protocol (MTP) 106. The device B 104 may communicate current object property values to another device A 102 upon initiation of communication or in response to an operation request such as GetObjectPropDesc and/or GetObjectPropValue for a specified object. A corresponding response from device B 104 may comprise an MTP ObjectPropDesc dataset and/or a current value from the DevicePropDesc dataset. Object marking properties may comprise, for example, TimestampOrigin, TimestampLastAccessed, Action, ModifyerIdentity and TimestampAndActionHistory.

In an embodiment of the invention, an extension of media transfer protocol (MTP) 106 may enable marking an object by specifying information about activity pertaining to the object. The specified information may be communicated to and/or from a device B 104 that supports MTP communications. The information about activity pertaining to an object or file may be recorded within one or more object properties. For example, a timestamp may be indicated within an object property with regard to when the corresponding object is received, generated and/or accessed. Furthermore, one or more object properties may indicate what action has occurred with regard to the object and who or what source triggered or executed the action. Moreover, one or more object properties may comprise a history or accumulation of information about activity pertaining to an object, for example, when an activity occurred, which activity occurred and/or who or what source initiated or executed the activity.

In various embodiments of the invention, a device B 104 may communicate the information about activity pertaining to an object to another device A 102 during initiation of communication between the devices. In addition, the information about activity pertaining to an object may be communicated or specified in a response to a request for the information. For example, one or more MTP operations such as GetObjectPropDesc or GetObjectPropValue may request the activity information and a corresponding response may comprise an ObjectPropDesc dataset or current value of the object property from the ObjectPropDesc dataset respectively. In this manner, an object may be marked with regard to utilization or activity involving the object and the marked information may be communicated via MTP. In addition, the information about activity pertaining to an object may be logged and/or audited based on the object properties.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for specifying timestamp properties for object marking and protocol exchange.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for handling multimedia information, the method comprising: specifying, based on an extension of a media transfer protocol (MTP), information about activity pertaining to an object and/or communicating said information to and/or from a device that communicates via said MTP.

2. The method according to claim 1, comprising indicating said information about activity pertaining to an object, via one or more MTP object properties.

3. The method according to claim 2, comprising indicating a timestamp via said one or more MTP object properties when an object is received and/or generated.

4. The method according to claim 2, comprising indicating a timestamp via said one or more MTP object properties when an object is accessed.

5. The method according to claim 2, comprising indicating an action pertaining to said object via said one or more MTP object properties.

6. The method according to claim 2, comprising indicating an identity of a source of action pertaining to said object via said one or more MTP object properties.

7. The method according to claim 2, comprising indicating a timestamp and action history pertaining to said object via said one or more MTP object properties.

8. The method according to claim 1, wherein said device communicates said information about activity pertaining to said object to another device when said device initiates communication with said another device.

9. The method according to claim 1, comprising specifying said information about activity pertaining to said object in response to a request.

10. The method according to claim 9, wherein said request comprises an MTP GetObjectPropDesc operation.

11. The method according to claim 9, wherein said response comprises an MTP ObjectPropDesc dataset.

12. The method according to claim 9, wherein said request comprises a GetObjectPropValue operation.

13. The method according to claim 9, wherein said response comprises data from a current value field of an MTP ObjectPropDesc dataset.

14. The method according to claim 1, comprising logging and/or auditing information about activity pertaining to an object based on one or more MTP object properties.

15. A system for handling multimedia information, the system comprising: at least one processor that specifies, based on an extension of a media transfer protocol (MTP), information about activity pertaining to an object and/or communicating said information to and/or from a device that communicates via said MTP.

16. The system according to claim 15, wherein said at least one processor enables indication of said information about activity pertaining to said object, via one or more MTP object properties.

17. The system according to claim 16, wherein said at least one processor enables indication of a timestamp via said one or more MTP object properties when an object is received and/or generated.

18. The system according to claim 16, wherein said at least one processor enables indication of a timestamp via said one or more MTP object properties when an object is accessed.

19. The system according to claim 16, wherein said at least one processor enables indication of an action pertaining to said object via said one or more MTP object properties.

20. The system according to claim 16, wherein said at least one processor enables indication of an identity of a source of action pertaining to said object via said one or more MTP object properties.

21. The system according to claim 16, wherein said at least one processor enables indication of a timestamp and action history pertaining to said object via said one or more MTP object properties.

22. The system according to claim 15, wherein said device communicates said information about activity pertaining to said object to another device when said device initiates communication with said another device.

23. The system according to claim 15, wherein said at least one processor enables specification of said information about activity pertaining to said object in response to a request.

24. The system according to claim 23, wherein said request comprises an MTP GetObjectPropDesc operation.

25. The system according to claim 23, wherein said response comprises an MTP ObjectPropDesc dataset.

26. The system according to claim 23, wherein said request comprises a GetObjectPropValue operation.

27. The system according to claim 23, wherein said response comprises data from a current value field of an MTP ObjectPropDesc dataset.

28. The system according to claim 15, wherein said at least one processor enables logging of and/or auditing of information about activity pertaining to an object based on one or more MTP object properties.

29. A machine-readable storage having stored thereon, a computer program having at least one code section for handling multimedia information, the at least one code section being executable by a machine for causing the machine to perform steps comprising:
specifying, based on an extension of a media transfer protocol (MTP), information about activity pertaining to an object and/or communicating said information to and/or from a device that communicates via said MTP.

30. The machine-readable storage according to claim 29, wherein said at least one code section comprises code for indicating said information about activity pertaining to said object, via one or more MTP object properties.

31. The machine-readable storage according to claim 30, wherein said at least one code section comprises code for indicating a timestamp via said one or more MTP object properties when an object is received and/or generated.

32. The machine-readable storage according to claim 30, wherein said at least one code section comprises code for indicating a timestamp via said one or more MTP object properties when an object is accessed.

33. The machine-readable storage according to claim 30, wherein said at least one code section comprises code for indicating an action pertaining to said object via said one or more MTP object properties.

34. The machine-readable storage according to claim 30, wherein said at least one code section comprises code for indicating an identity of a source of action pertaining to said object via said one or more MTP object properties.

35. The machine-readable storage according to claim 30, wherein said at least one code section comprises code for indicating a timestamp and action history pertaining to said object via said one or more MTP object properties.

36. The machine-readable storage according to claim 29, wherein said device communicates said information about activity pertaining to said object to another device when said device initiates communication with said another device.

37. The machine-readable storage according to claim 29, wherein said at least one code section comprises code for specifying said information about activity pertaining to said object in response to a request.

38. The machine-readable storage according to claim 37, wherein said request comprises an MTP GetObjectPropDesc operation.

39. The machine-readable storage according to claim 37, wherein said response comprises an MTP ObjectPropDesc dataset.

40. The machine-readable storage according to claim 37, wherein said request comprises a GetObjectPropValue operation.

41. The machine-readable storage according to claim 37, wherein said response comprises data from a current value field of an MTP ObjectPropDesc dataset.

42. The machine-readable storage according to claim 37, wherein said at least one code section comprises code for logging and/or auditing information about activity pertaining to an object based on one or more MTP object properties.
